(19) United States
(12) Patent Application Publication
(10) Pub. No.: US 2026/0248074 A1
(43) Pub. Date: Aug. 27, 2026

(54) BALER CROP SPEED TRACKING

(71) Applicant: AGCO Corporation, Duluth, GA (US)

(72) Inventor: James Michael Davis, Hesston, KS (US)

(21) Appl. No.: 19/415,717

(22) Filed: Dec. 10, 2025

Related U.S. Application Data
(60) Provisional application No. 63/730,616, filed on Dec. 11, 2024.

(51) Int. Cl. A01F 15/08

(52) U.S. Cl. CPC A01F 15/0825

(57) ABSTRACT

An agricultural baler includes at least two sensors 116a, 116b configured to detect a variable characteristic of baled non-homogeneous crop material. The sensors are positioned serially in a longitudinal path of the bale as the bale moves rearwardly in the baling chamber, with sensor 116b being spaced from sensor 116a in a longitudinal direction by a sensor spacing distance 120. Each of the sensors is mounted in the baling chamber in such a manner that each of the sensors detects the variable characteristic of crop material of the bale at a plurality of sample points along a sample line as the bale is pushed towards a discharge end 114 of the baling chamber. A controller identifies time differences between coordinated identifying events on sensor profiles generated for the sensors and using the sensor spacing distance determines the speed of movement of a bale.

### CROSS-REFERENCE TO RELATED APPLICATION

This application claims the benefit of the filing date of U.S. Provisional Patent Application 63/730,616, filed Dec. 11, 2024, the entire disclosure of which is incorporated herein by reference.

### FIELD

This disclosure relates to agricultural harvesting machines such as balers and, more particularly, to a bale shape monitoring system for a baler.

### DESCRIPTION OF RELATED ART

Square balers as they are commonly called are used in the agricultural industry to create substantially rectangular, bales of crop material by moving over crop windrows to collect loose crop material, compress it, and form it into bales that are then tied and ejected from the baler. To that end, a baler is typically mechanically coupled with a tractor, and a power take-off (PTO) mechanism transfers power from the tractor's engine to drive the baler's operation. A rotary pick-up at the front of the baler picks up the loose crop material and moves it into a stuffer chamber. Once the stuffer chamber is full, its content, which may be referred to as a “charge,” is moved through a stuffer chute into a baling chamber. A reciprocating plunger compresses the charge of crop material into a growing bale. Once the bale reaches a predetermined length it is tied and ejected through a discharge outlet to fall onto the ground behind the baler. The process continues to create the next bale.

However, crop windrows are not always perfectly uniform across their widths, so charges with volumes that are uneven from one side to the other are sometimes fed into the baling chamber. Additionally, crop windrows may have uneven densities and the accumulated crop material collected in the stuffer chamber may be moved into the baling chamber before the stuffer chamber is completely full causing a smaller charge. Smaller charges tend to result on more crop material in the upper portion of the baling chamber causing the bales to be uneven top to bottom. Furthermore, even when the crop windrows are substantially uniform, operators sometimes deviate from perfect positioning over them, which can also result in the charges having uneven densities. When uneven charges are incorporated into growing bales, components of the baling system can experience uneven stresses, and the finished bales may be curved or otherwise misshapen which can adversely affect securing them with twine and subsequently handling and stacking them. Uneven feeding causes the bale to pass through the baling chamber at uneven speeds. Without some form of feedback, there is no practical way for an operator to know of the problem and take actions to correct it.

A drawback of the known agricultural balers is that mechanisms to determine the speed of the bale passing through the baling chamber are complex and unreliable.

### BRIEF SUMMARY

In one aspect the invention is directed to an agricultural baler configured to move over a field and collect cut crop material and to compress, shape, and secure the collected plant material into a non-homogeneous compressed bale. The baler has a reciprocating plunger moving in a baling chamber. The baler includes at least two sensors configured to detect a variable characteristic of the baled non-homogeneous crop material, where the sensors are positioned serially in a longitudinal path of the bale of compressed crop material as the bale moves rearwardly in the baling chamber, with sensor being spaced from sensor in a longitudinal direction by a sensor spacing distance 120. Each of the sensors is mounted in the baling chamber in such a manner that each of the sensors detects the variable characteristic of crop material of the bale at a plurality of sample points along a sample line as the bale is pushed towards a discharge end of the baling chamber. A controller is configured to receive variable characteristic signals over time from the sensors for the plurality of sample points along the sample line and generate a sensor profile for the bale from each of the sensors. The controller identifies time differences between coordinated identifying events on the sensor profiles for the sensors and using the sensor spacing distance determines the speed of movement of a bale.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE SEVERAL VIEWS OF THE DRAWING

To easily identify the discussion of any particular element or act, the most significant digit or digits in a reference number refer to the figure number in which that element is first introduced.

FIG. 1 shows a schematical side-view representation of a baler having series of sensors in the baling chamber;

FIG. 2 illustrates a graph of sensor profiles generated by the series of sensors in FIG. 1; and

FIG. 3 illustrates an embodiment of a controller.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

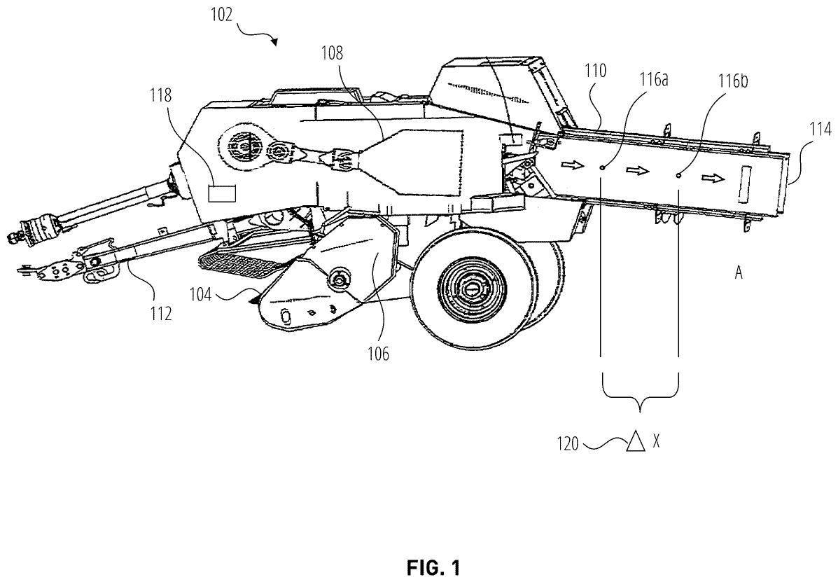

Referring to FIG. 1, an example agricultural baler 102 is shown into which embodiments of the present invention may be incorporated. Broadly, the baler 102 may be configured to move over a field and collect previously cut plant material and to compress, shape, and secure the collected plant material into a plurality of bales. The baler 102 may generally include a pickup assembly 104, stuffer assembly 106, a reciprocating plunger 108, and a baling (or compression) baling chamber 110. Additionally, the baler may be hitched to a towing vehicle (not shown) by a tongue 112, and power for operating the various mechanisms (e.g., the reciprocating plunger 108) of the baler 102 may be supplied by a power take-off of the towing vehicle. The baler 102 is depicted as an “in-line” type of baler wherein crop material is picked up below and slightly ahead of baling chamber 110 and then loaded up into the bottom of baling chamber 110 in a straight-line path of travel. The pickup assembly 104 is positioned under the tongue 112 on the longitudinal axis of the machine, somewhat forwardly of the baling chamber 110.

As is known, the stuffer assembly 106 may include a charge forming stuffer chamber that in one embodiment is curvilinear in shape that extends generally rearwardly and upwardly from an inlet opening just behind the pickup assembly 104 to an outlet opening at the bottom of the baling chamber 110. In some embodiments, the stuffer chamber may comprise a straight duct configuration, among other geometries. One having ordinary skill in the art should appreciate in the context of the present disclosure that the example stuffer assembly 106 and cooperating elements and/or sub-assemblies are merely illustrative, and that other types of configurations may be implemented in some embodiments. The plunger 108, as is known, reciprocates within the baling chamber in compression and retraction strokes across the opening at the bottom of the baling chamber to compress the plant material from the stuffer assembly 106 into a growing bale. In the portion of the plunger stroke forward of the opening, the plunger 108 uncovers the duct outlet opening, and in the rear portion of the stroke, the plunger 108 completely covers and closes off the outlet opening. The reciprocating plunger 108 may be configured to reciprocate within the baling chamber 110 in repeating compression and retraction strokes. As the plunger 108 retracts, the outlet opening is uncovered and an additional flake, charge, or other subunit of plant material enters the baling chamber 110, and as the plunger 108 contracts the outlet opening is covered, and the additional subunit of plant material is compressed into the growing bale. The finished bale may be ejected from a discharge end 114 of the baling chamber 110 and then dropped to land on the field behind the baler 102 for subsequent collection.

According to the invention, the baling chamber 110 is further provided with a series of sensors 116 comprising at least two sensors, such as sensors 116a and 116b, as shown in FIG. 1. The sensors 116 are configured to detect a variable characteristic of the baled crop material. The sensors 116 are positioned serially in a longitudinal path of the bale of compressed crop material as the bale moves rearwardly along the baling chamber 110 as shown by arrows in FIG. 1, with sensor 116b being spaced from sensor 116a by a sensor spacing distance 120. A controller 118, which may be on the baler 102 or on the towing vehicle, is configured to receive information from the sensors 116 and track the sensed variable characteristics of the baled crop as the bale moves past each of the sensors 116 so that the movement of a bale can be tracked over time as explained below. Each sensor 116 may be a suitable sensor such as a moisture or optical sensor configured to read a variable characteristic of the crop material. Since sensors configured to read variable characteristics of crop material are known to one skilled in the art, operation of the sensors 116 need not be described herein.

Each sensor 116 is mounted to a surface of the baling chamber 110 or to the frame of the baler 102 in such a manner that the sensor 116 is directly adjacent to the crop material in the baling chamber 110 when the baler 102 is in operation. Each sensor 116 will detect the variable characteristic at a sampling point on the surface of crop material of the bale in the baling chamber 110 at the location proximal to the sensor 116. As the bale is being pushed further back towards the discharge end 114 of the baling chamber 110, the sensor 116 will be exposed to a number of sampling points in a line along the bale and will detect the variable characteristic at the number of sampling points. As the crop material in the bale is not a homogeneous material, the signal generated by the sensor 116 will change as different sampling points of the bale are exposed to the sensor based on the non-uniform composition of the crop material.

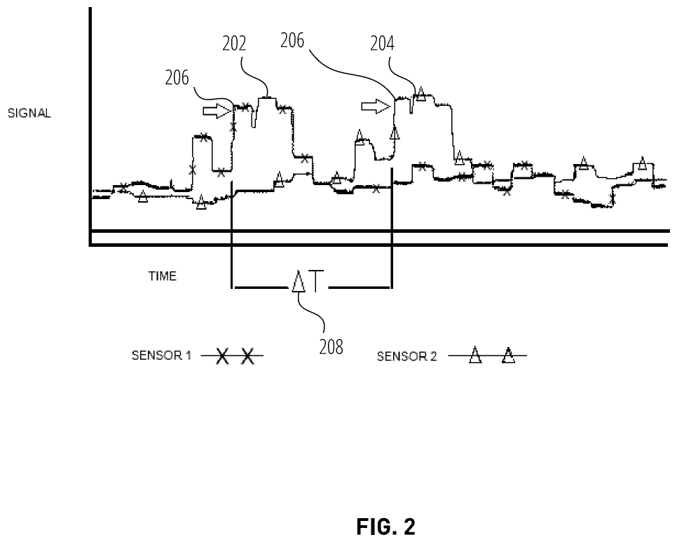

The controller 118 receives the variable characteristic signals over time from the sensor 116 for the series of sample points along the length of the bale and generates a signal profile for the bale. Turning now to the graph of sensor signal over time as shown in FIG. 2, the controller 118 generates a signal sensor profile for each of the sensors 116. In the illustrated example, a sensor profile 202 for sensor 116a is generated that has variations over time as the bale moves past the sensor 116a. The sensor profile 202 has a number of different identifying events such as event 206 caused by differences in the received signal due to differences in the variable characteristic of the non-homogeneous material being read by sensor 116a. Sensor 116b will likewise generate a sensor profile 204 that has variations over time as the bale moves past the sensor 116b. Since sensor 116a and sensor 116b are positioned in-line along the longitudinal direction of the baling chamber 110, the sensors 116a and 116b will be exposed to the same sampling points on the bale, only at different times based on movement of the bale in the baling chamber 110. Accordingly, the sensor profiles 202 and 204 will have substantially the same shape but offset by time since sensor 116b is reading the same sample points on the bale as were read by sensor 116a after the bale has moved further back in the baling chamber 110.

The controller 118 compares the sensor profiles 202 and 204 and identifies corresponding events 206 in the two profiles and the time each event 206 was occurs in the sensor profiles. The controller 118 then determines a time difference 208 between corresponding identifying events 206 in the sensor profiles 202 and 204. Using the time difference generated by the successive sensor profiles 202 and 204 and the known spacing distance 120 between sensor 116a and sensor 116b, the velocity at which the bale is moving inside the baling chamber 110 is calculated by the controller 118 such as by using Eq. 1.

$$Velocity = Delta X / Delta T \qquad ( EQ . 1 )$$

The calculated velocity of the bale in the baling chamber 110 can be output by the controller 118 using a suitable interface as will be described below. FIG. 1 shows the sensors 116a and 116b provided at a side surface of the baling chamber. However, one skilled in the art will understand that the location of the sensors 116a, 116b in the longitudinal direction of the baler 102 can be amended. For example, the sensors 116a, 116b can be provided in a top portion of the baling chamber 110. Additionally, while two sensors 116 are shown in the illustrated embodiment of the series of sensors, three, four or even more sensors 116 may be used without departing from the scope of the invention.

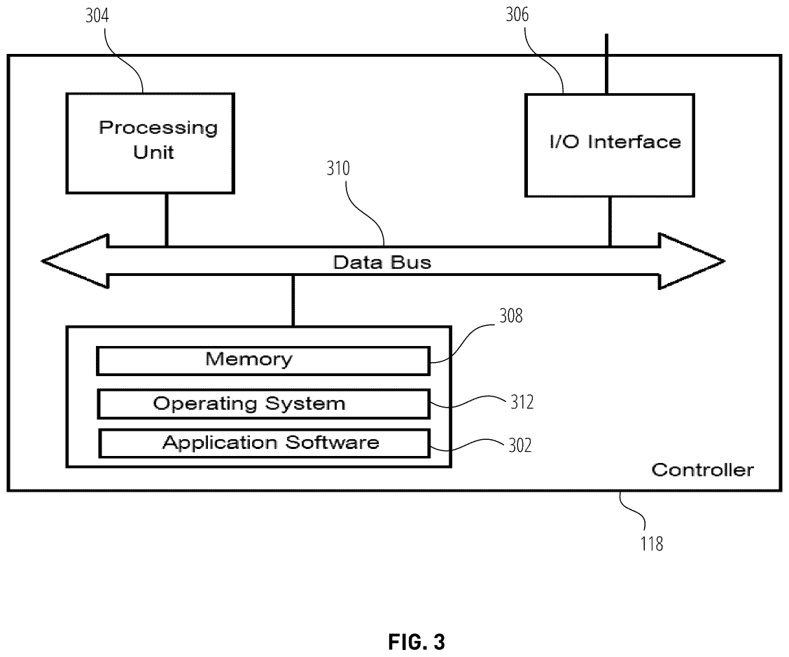

Referring now to FIG. 3, an embodiment of the example controller depicted in FIG. 1, which comprises a computer architecture, is shown. The controller 118 is configured with application software 302 that receives measurements from the sensors 116 in the baling chamber 110, generates the sensor profiles and determines the velocity of the bale in the baling chamber 110. It should be appreciated by one having ordinary skill in the art that the controller depicted in FIG. 3 is one example illustration, and that in some embodiments, fewer, greater, and/or different computer architecture components may be used. Also, it should be appreciated by one having ordinary skill in the art that certain well-known components of computer systems are omitted here to avoid obfuscating relevant features of the controller 118.

In one embodiment, the controller 118 comprises one or more processing units 304, input/output (I/O) interface(s) 306, and memory 308, all coupled to one or more data busses, such as data bus 310. The memory 308 may include any one or a combination of volatile memory elements (e.g., random-access memory RAM, such as DRAM, SRAM, and SDRAM, etc.) and nonvolatile memory elements (e.g., ROM, Flash, solid state, EPROM, EEPROM, hard drive, CDROM, etc.). The memory 308 may store a native operating system, one or more native applications, emulation systems, or emulated applications for any of a variety of operating systems and/or emulated hardware platforms, emulated operating systems, etc. In the embodiment depicted in FIG. 3, the memory 308 comprises an operating system 312 and the application software 302. The application software 302 comprises executable code that receives input from the sensors 116 corresponding to the variable characteristics of the crop material. The application software 302, generates the sensor profiles 202, 204, calculates the time difference 208 between corresponding events 206, and calculates the velocity of the bale using the spacing distance 120. The bale velocity may be displayed using the interface 306. Additional software may be used in some embodiments, including graphical user interface (GUI) software, browser software, communications software, etc. It should be appreciated that the application software 302 may be distributed among one or more software modules in the controller 118, or distributed in whole or in part in a remote computing device. In some embodiments, a separate storage device may be coupled to the data bus 310 or coupled via the I/O interfaces 306, such as a persistent memory (e.g., optical, magnetic, and/or semiconductor memory and associated drives).

Execution of the application software 302 is implemented by the processing unit 304 under the auspices of the operating system 312. In some embodiments, the operating system 312 may be omitted and a more rudimentary manner of control implemented. The processing unit 304 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 118. Note that the controller 118 may comprise additional functionality, including one or more of the functions provided by the control system.

When certain embodiments of the controller 118 are implemented at least in part in logic configured as software/firmware, as depicted in FIG. 3, it should be noted that the logic can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program for use by or in connection with a computer-related system or method. The logic may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 118 are implemented at least in part in logic configured as hardware, such functionality may be implemented with any or a combination of the following technologies, which are all well-known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. An agricultural baler configured to move over a field and collect cut crop material and to compress, shape, and secure the collected plant material into a non-homogeneous compressed bale, the baler having a reciprocating plunger 108 moving in a baling chamber 110, wherein the baler comprises:
at least two sensors configured to detect a variable characteristic of the baled non homogeneous crop material, wherein the sensors are positioned serially in a longitudinal path of the bale of compressed crop material as the bale moves rearwardly in the baling chamber, with sensor being spaced from sensor in a longitudinal direction by a sensor spacing distance, and wherein each of the sensors is mounted in the baling chamber in such a manner that each of the sensors detects the variable characteristic of crop material of the bale at a plurality of sample points along a sample line as the bale is pushed towards a discharge end of the baling chamber; and
a controller configured to receive variable characteristic signals over time from the sensors for the plurality of sample points along the sample line and generate a sensor profile for the bale from each of the sensors, wherein the controller identifies time differences between coordinated identifying events on the sensor profiles for the sensors and using the sensor spacing distance determines a speed of movement of a bale.

2. The agricultural baler of claim 1, wherein each generated sensor profile has a plurality of different identifying events caused by differences in the received signal due to differences in the variable characteristic of the non-homogeneous material being read by the sensor.

3. The agricultural baler of claim 1, wherein each of the sensors is a moisture sensor.

4. The agricultural baler of claim 1 wherein each of the sensors is an optical sensor.
